(19) United States
(12) Patent Application Publication
(10) Pub. No.: US 2023/0342613 A1
(43) Pub. Date: Oct. 26, 2023

(54) SYSTEM AND METHOD FOR INTEGER ONLY QUANTIZATION AWARE TRAINING ON EDGE DEVICES

(71) Applicant: ALPHAICS CORPORATION, MILPITAS, CA (US)

(72) Inventors: SOORAJ KOVOOR CHATHOTH, BENGALURU (IN); SHIVAM GARG, HARYANA (IN); VAIBHAV NANDWANI, HARYANA (IN)

(21) Appl. No.: 17/725,500

(22) Filed: Apr. 20, 2022

(51) Int. Cl. G06N 3/08

(52) U.S. Cl. CPC G06N 3/084

(57) ABSTRACT

A system and a method for integer only quantization aware training on an edge device is disclosed. The method includes 1) computing a pseudo cross entropy and a loss function based on a gradient stabilization and a gradient delta stabilization, and a residual weight error; 2) computing a gradient and performing a back propagation by converting of integer values to floating point values and updating the gradient; 3) updating weights parameters corresponding to gradients with a low precision; and 4) adjusting the residual weight error and repeating the steps 1 to 4 for a predetermined number of epochs.

### BACKGROUND

### Technical Field

The embodiments herein are generally related to a quantization in learning based systems. The embodiments herein are particularly related to system and method for integer only quantization aware training on edge devices.

### Description of the Related Art

Typically, real-world applications of deep neural networks are increasing by the day as we are learning to make use of artificial intelligence to accomplish various simple and complex tasks. However, the problem with deep neural networks is that they involve too many parameters due to which they require powerful computation devices and large memory storage. Moreover, it is also expensive to run these networks on the cloud, while technology is shifting from cloud to edge devices, which does not support such high computation. This renders it almost impossible to run on devices with lower computation power such as Android and other low-power edge devices. Currently, optimization techniques such as quantization can be utilized to solve the above issue. With the help of different quantization techniques, the precision of parameters can be reduced from float to lower precision such as int8, resulting in efficient computation and less amount of storage. Quantization involves converting the weights from float precision to integer precision in order to save computation resources and to consume less memory, which results in faster inference on certain hardwares. Although there is a tradeoff with quantization, we sometimes lose a significant amount of accuracy after converting the weights to lower precision.

The currently known techniques of quantisation use direct mapping of floating weights/activations to integer range that also make use of zero points and sometimes use (0-255) range for activations like relu and simulating fake quantization while training. However, in direct mapping, while inference is the zero point, it involves additional computation that in turn degrades the performance for edge devices, especially those that support INT8 only arithmetic. Also, to achieve better accuracy these methods incorporate per axis quantization hence further increasing computation overhead. While training, these techniques simulate or fake quantization and consequently the real updates to gradient are done in floating only hence training cannot be done on platforms that support INT8 only arithmetic. Yet another technique used current includes post training quantization, that involves mapping the floating range to integer range by optimizing some similarity metric like KL divergence, cosine similarity or combination of other metrics on a small subset of dataset or calibration dataset. The transformation or mapping can be carried out by using linear or non-linear metrics. The linear metric is used more often due to simplicity and hardware friendly quantisation/de-quantisation operations. In the post training quantisation, the floating value is given by: floating_value=scaling_factor*(integer_value−zi)+zr, zi, zr being zero points.

However, calculating this zero-point on the fly increases the computation overhead, which sometimes even make the model comparable in time to its floating counterpart. Additionally, to compensate for this one can make both zi, zr to be zero for some layers of network so to get a speed/accuracy trade-off. Also, the scaling factor can be broken into an equivalent multiplier and a shiftier so as to perform all the operation in integer range. The above method works well for the cases where per channel variation in filters are negligible or can be made by fusing them altogether as in the case of batch norms and convolution. When the depth wise convolution is present in the network (or worse a combo of it with batch norm) then this mapping can be very lossy and unreliable. To compensate that, researches have used per channel and per axis quantization, however it significantly reduces the inference speed and is also hectic to perform on INT only hardware. Yet another technique currently used is quant aware training (QAT). The QAT is beneficial as simply converting using post quantization leads to a significant drop in accuracy. Using QAT, another chance is given to the model to adapt to the integer weights and improve its performance. This results in almost no accuracy drop after quantization. In the currently known QAT techniques, the inference-time quantization is emulated during training, so that the quant-aware training simulates low precision behavior in the forward pass, while the backward pass remains the same. This induces some quantization error which is accumulated in the total loss of the model and hence the optimizer tries to reduce it by adjusting the parameters accordingly. This makes the parameters more robust to quantization making our process almost lossless. Two new parameters have been introduced for this purpose that includes scale and zero-point. As the name suggests scale parameter is used to scale back the low-precision values back to the floating-point values. It is stored in full precision for better accuracy. On the other hand, zero-point is a low precision value that represents the quantized value that will represent the real value 0. The advantage of zero-point is that we can have a wider range for integer values even for skewed tensors.

Main role of quantize operation is to bring the float values of a tensor to low precision integer values. it is done based on the above-discussed quantization scheme. The main role of scale is to map the lowest and highest value in the floating range to the highest and lowest value in the quantized range. We can find the zero-point by establishing a linear relationship between the extreme floating-point values and the quantized values. Zero-point is also called quantization bias or offset as it represents zero of floating range in the quantized range. typically, to obtain real values back from quantized values, we use the de-quantize operation. after using quantize and dequantize operations together, we get our values back in floating range, although quantization error is induced in the forward propagation and our optimizer will try to minimize that error. although the main shortcomings of the approach is that the scales and zero-point are generally per-axis i.e., there will be a separate scale and zero point for each channel and most inference hardwares will not be able to support it. Most hardwares generally have one scaling operator per tensor and hence this method is not suitable. Another shortcoming of this method is, we cannot perform the training on Integer optimized inference hardware as the gradients used in this method are in original form i.e., float, hence we would need a host machine capable of float operations.

Hence, there is a need for a system and a method that has the ability to perform integer only backprop (Full Integer only quantization), while using better prior while performing the Quantization Aware Training and a highly efficient integer only cross entropy (Pseudo cross entropy), and also stabilizes gradients and its changes.

The abovementioned shortcomings, disadvantages and problems are addressed herein and which will be understood by reading and studying the following specification.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a computer-implemented method for integer only quantization aware training on an edge device. The method includes 1) computing a pseudo cross entropy and a loss function based on a gradient stabilization and a gradient delta stabilization, and a residual weight error. The method also includes 2) computing a gradient and performing a back propagation by converting of integer values to floating point values and updating the gradient. The method also includes 3) updating weights parameters corresponding to gradients with a low precision. The method furthermore includes 4) adjusting the residual weight error and repeating the steps 1 to 4 for a predetermined number of epochs.

According to an embodiment herein, computing the pseudo cross entropy loss function includes computing a gradient stabilization and a gradient delta stabilization, computing an integer only softmax, wherein the integer only softmax is given by: 2*x/sum(2*x) where x is an input, and adjusting multiplier and shift values error based on the integer only softmax.

According to an embodiment herein, the method further includes determining if a performance is acceptable after every predetermined number of epochs, starting a quant aware training (QAT) upon the performance not being acceptable, by transferring the training data to the edge device, and continuing performing inference upon the performance being acceptable, by using a real time feed.

According to an embodiment herein, the method further includes, performing prior to continuing inference: pre-training a floating model on a full dataset, performing a post training quantisation, determining if a predetermined accuracy is achieved, repeating steps 2) and 3) upon the predetermined accuracy not being achieved, and obtaining integer weights biases and activation scales and transferring to edge devices upon the predetermined accuracy being achieved and continue performing interference.

According to an embodiment herein, the computing the gradient includes applying a gradient restriction by tracking a mean of gradient change with respect to an earlier gradient based on (delta gradient-mean (delta gradient))**2. A variance of the delta gradient is within a predetermined range, and wherein post quantization trained weights are used as prior for a first gradient change.

According to an embodiment herein, the method further includes adding (abs(gradient)−n)**2 to loss function for restricting the gradient to be within n, and adding a delta of gradient in a subtracted delta gradient mean for each layer to constrain the gradient change, wherein the delta gradient is added based on equation:

gradient_change_restriction=(delta gradient−mean(delta gradient))**2.

According to an embodiment herein, the method further includes 1) checking a scale in an interquartile range (IQR) of gradient for re-mapping and adding the IQR of the gradients to the loss function, 2) modifying a cross entropy of the loss function to an integer only pseudo_cross_entropy, wherein the loss function is given by equation:

loss_function=pseudo_cross_entropy+gradient_restriction+gradient_change_restriction+weights_resiudal_error(MUL/SHIFT error;
3) replacing a softmax with 2 in e and mapping a max with 2**31, where a custom softmax is given by equation:

custom softmax=2**mapped_value_class/sum(2**mapped_classes);
and where pseudo cross entropy is given by equation:

pseudo cross entropy=log 2(class_nearest_shift)−log 2(class_nearest_mul)(for all class)−(log 2(sum_nearest_shift)+log 2(sum_nearest_mul))*num_classes,
and 4) recursively repeating steps 1) to 3) for 5 to 10 cycles.

The various embodiments herein provide a system for integer only quantization aware training on an edge device. The system includes a memory for storing one or more executable modules and a processor for executing the one or more executable models for integer only quantization aware training. The one or more executable modules includes a pseudo cross entropy module configured to compute a pseudo cross entropy and a loss function based on a gradient stabilization and a gradient delta stabilization, and a residual weight error, a gradient module for computing a gradient and performing a back propagation by converting of integer values to floating point values and updating the gradient, a weight update module for updating weights parameters corresponding to gradients with a low precision, an error adjustment module for adjusting the residual weight error.

According to an embodiment herein, the pseudo cross entropy module is further configured to compute a gradient stabilization and a gradient delta stabilization, compute an integer only softmax, wherein the integer only softmax is given by: 2*x/sum(2*x) where x is an input, and adjust multiplier and shift values error based on the integer only softmax.

According to an embodiment herein, the system further includes a training module for performing the steps of: determining if a performance is acceptable after every predetermined number of epochs, starting a quant aware training (QAT) upon the performance not being acceptable, by transferring the training data to the edge device, and continuing performing inference upon the performance being acceptable, by using a real time feed.

According to an embodiment herein, the training module is further configured for performing prior to continuing inference:
1) pre-training a floating model on a full dataset;
2) performing a post training quantisation;
3) determining if a predetermined accuracy is achieved;
4) repeating steps 2) and 3) upon the predetermined accuracy not being achieved; and
5) obtaining integer weights biases and activation scales and transferring to edge devices upon the predetermined accuracy being achieved and continue performing interference.

According to an embodiment herein, the gradient module is further configured for applying a gradient restriction by tracking a mean of gradient change with respect to an earlier gradient based on (delta gradient-mean (delta gradient))**2, where a variance of the delta gradient is within a predetermined range, and wherein post quantization trained weights are used as prior for a first gradient change.

According to an embodiment herein, the gradient module is further configured for: adding (abs(gradient)−n)**2 to loss function for restricting the gradient to be within n and adding a delta of gradient in a subtracted delta gradient mean for each layer to constrain the gradient change, wherein the delta gradient is added based on equation:

gradient_change_restriction=(delta gradient−mean(delta gradient))**2.

According to an embodiment herein, the gradient module is further configured for:
1) checking a scale in an interquartile range (IQR) of gradient for re-mapping and adding the IQR of the gradients to the loss function; and
2) modifying a cross entropy of the loss function to an integer only pseudo_cross_entropy, wherein the loss function is given by equation:

loss_function=pseudo_cross_entropy+gradient_restriction+gradient_change_restriction+weights_resiudal_error(MUL/SHIFT error.
3) replacing a softmax with 2 in e and mapping a max with 2**31, wherein a custom softmax is given by equation:

custom softmax=2**mapped_value_class/sum(2**mapped_classes); and
wherein pseudo cross entropy is given by equation:

pseudo cross entropy=log 2(class_nearest_shift)−log 2(class_nearest_mul)(for all class)−(log 2(sum_nearest_shift)+log 2(sum_nearest_mul))*num_classes;

and
4) recursively repeating steps 1) to 3) for 5 to 10 cycles.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a system for integer only quantization aware training on edge devices, according to an embodiment herein.

FIGS. 2A-2B depict a flow chart illustrates a process for integer only quantization aware training on edge devices, according to an embodiment herein;

FIG. 3 depicts a schematic diagram for computing a loss function, according to an embodiment herein; and

FIG. 4 depicts a flow diagram illustrating the steps involved in the method for integer only quantization aware training on edge devices, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF PREFERRED EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The various embodiments herein provide a system and a method for performing an integer only quantization, while using better prior while performing the quantization aware training and a highly efficient integer only cross entropy (pseudo cross entropy), and also stabilizes gradients and its changes. Various embodiments of the present technology perform full integer only quantization aware training and therefore can be used in full integer only hardware. Additionally, various operations of the present system require 8 bits or very rarely 32 bit for calculating some metrics and accordingly the present system is highly memory efficient. Moreover, since only bit shift and addition are used, the present technology is compatible with every hardware without the need of any complex hardware instruction set or advanced software implementations.

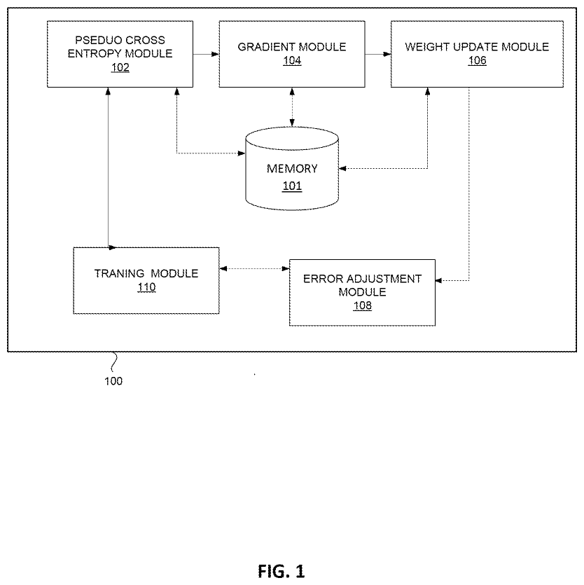

The various embodiments disclosed herein provide system and method for integer only quantization aware training on edge devices. Referring now to the drawings, and more particularly to FIGS. 1 through 4, where similar reference characters denote corresponding features consistently throughout the figures, preferred embodiments are shown.

FIG. 1 illustrates a block diagram of a system 100 for integer only quantization aware training on an edge device, according to an embodiment herein. The system 100 includes a memory 101 comprising one or more executable modules. The one or more executable modules includes a pseudo cross entropy module 102, a gradient module 104, a weight update module 106, an error adjustment module 108, and a training module 110. The one or more modules are executable by a processor (not shown) for integer only quantization aware training on edge device. Examples of the edge device include, but is not limited to,

In an embodiment, the pseudo cross entropy module 102 is configured to compute a pseudo cross entropy and a loss function based on a gradient stabilization and a gradient delta stabilization, and a residual weight error. The pseudo cross entropy module 102 is further configured to compute a gradient stabilization and a gradient delta stabilization, compute an integer only softmax, wherein the integer only softmax is given by: 2*x/sum(2*x) where x is an input, and adjust multiplier and shift values error based on the integer only softmax.

In an embodiment, the gradient module 104 is configured to compute a gradient and performing a back propagation by converting of integer values to floating point values and updating the gradient. In an embodiment, the gradient module 104 is configured to add (abs(gradient)−n)**2 to loss function for restricting the gradient to be within n and add a delta of gradient in a subtracted delta gradient mean for each layer to constrain the gradient change.

In an embodiment, the gradient module 104 is further configured for 1) checking a scale in an interquartile range (IQR) of gradient for re-mapping and adding the IQR of the gradients to the loss function and 2) modifying a cross entropy of the loss function to an integer only pseudo cross entropy, and 3) replacing a softmax with 2 in e and mapping a max with 2**31, and 4) recursively repeating steps 1) to 3) for 5 to 10 cycles. In an embodiment, the gradient module 104 is further configured for applying a gradient restriction by tracking a mean of gradient change with respect to an earlier gradient based on (delta gradient-mean (delta gradient))**2, where a variance of the delta gradient is within a predetermined range, and wherein post quantization trained weights are used as prior for a first gradient change.

In an embodiment, the training module 110 is configured for determining if a performance is acceptable after every predetermined number of epochs, starting a quant aware training (QAT) upon the performance not being acceptable, by transferring the training data to the edge device, and continuing performing inference upon the performance being acceptable, by using a real time feed.

In an embodiment, the training module 110 is further configured for performing prior to continuing inference:
6) pre-training a floating model on a full dataset;
7) performing a post training quantisation;
8) determining if a predetermined accuracy is achieved;
9) repeating steps 2) and 3) upon the predetermined accuracy not being achieved; and
10) obtaining integer weights biases and activation scales and transferring to edge devices upon the predetermined accuracy being achieved and continue performing interference.

In an embodiment, the weight update module 106 is configured to update weights parameters corresponding to gradients with a low precision. In an embodiment, the error adjustment module 108 for adjusting the residual weight error.

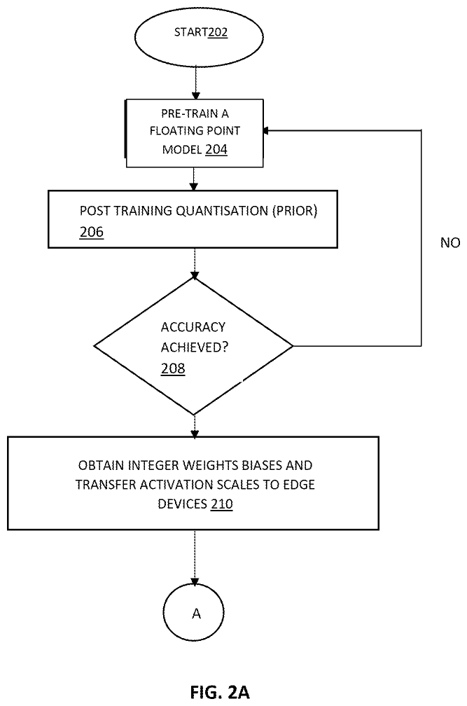

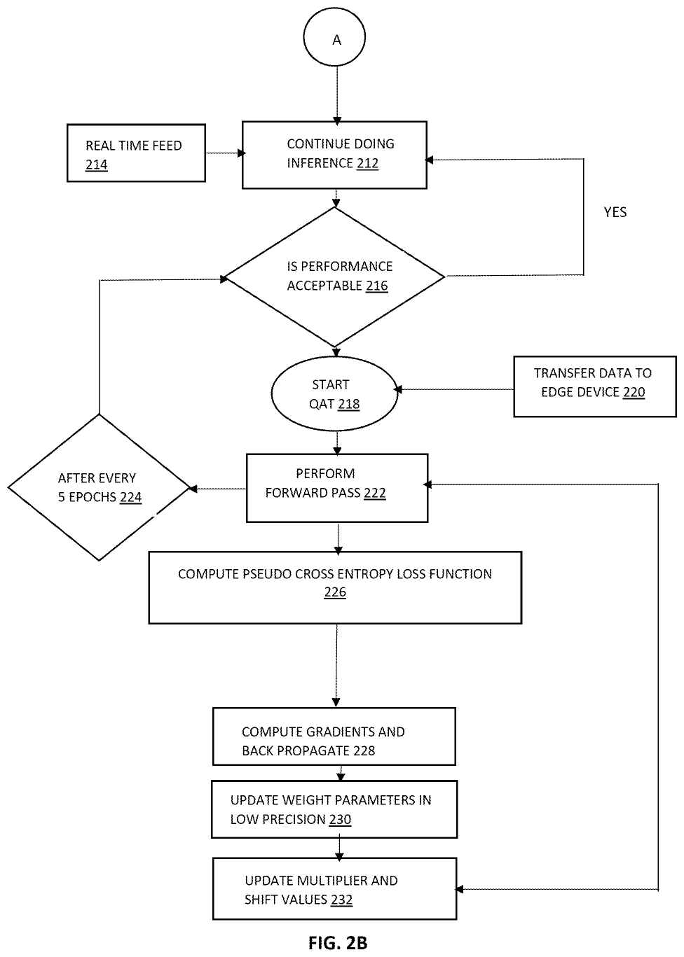

FIGS. 2A-2B depict a flow chart illustrating a process for integer only quantization aware training on edge devices, according to an embodiment herein. The process begins at step 202. At step 204, a floating point model is pre-trained on a full dataset. The floating point model includes, but is not limited to a deep learning model, a neural network model, and the like. At step 206, a post training quantization is performed on the pre-trained floating point model on a host device. At step 208, it is checked if a predetermined accuracy is achieved. If the predetermined accuracy is not achieved the steps 204-208 are repeated. Upon achieving the predetermined accuracy, at step 210, integer weights biases are obtained and activation scales are transferred to edge devices. At step 212, inference process is continued on the edge devices using real time feed 214. At step 216 it is determined if the performance is acceptable. Upon the performance being acceptable steps 212 to 216 is repeated. Upon the performance not being acceptable, at step 218, a quant aware training (QAT) is started, by transferring training data to the edge devices at step 220. In an embodiment, the QAT is used for achieving integer only quantization in edge devices. The post training quantization results can provide a good prior or starting point for QAT as they are already decided by some iterative heuristics. Also, the post trained multiplier and shifter scales are better than randomly initializing to match similarity between floating and integer ranges.

At step 222, a forward pass is performed and the process is repeated 224 for about 5 epochs. After 5 epochs, at step 226 a pseudo cross entropy loss function is computed. The pseudo cross entropy is a loss function that is used to solve classification problems mathematically and includes a sum((pgt)log(pout)) for all labels, where pout is the probability of the label model predicted and pgt is an original probability of the label. The computation is performed recursively till for 10 cycles or when the computations just hits recursive limit of 5 cycles. The computation has comparatively less error for calculating logs on an average and performs far better than other known standard log approximations.

The pseudo cross entropy is computed based on a gradient stabilization and a gradient delta stabilization. As used herein the term “gradient” refers to a derivative of a function that has more than one input variable, also known as the slope of a function in mathematical terms, the gradient simply measures the change in all weights with regard to the change in error. In order to reduce a probable great amount of variance in gradients the present technology restricts the gradient by using a soft method to smoothly restrict the gradient in a predetermined n range (for example n=6, as evident from relu6 that most of the activation manifold can be represented in values up to 6). This in turn restricts an information flow of gradient information in that predetermined range. The gradient restriction is given by equation (1):

gradient_restriction=(abs(gardient)−n)**2)n (1)

Since the variance of delta (gradient change) should be in a particular range, a good prior needs to be used. This is to further reinforce the idea that the gradient should not explode, so in order to avoid any abrupt change in gradient, the change in gradient is restricted by tracking the mean of gradient change with respect to earlier gradient by (delta gradient-mean (delta gradient))**2. In an embodiment, post quantization trained weights are used as prior for a very first gradient change. Accordingly, the present technology performs a QAT on the top of post quantization rather than starting training from scratch as done by most prior works. Additionally, in order to constrain the gradient change, a delta of gradient is added in the subtracted mean (delta gradient mean) for each layer trying to restrict it even further. The gradient change restriction is given by equation (2):

gradient_change_restriction=(delta gradient mean(delta gradient))**2 (2)

In an embodiment, a scale in an interquartile (IQR) range of gradient is checked for re-mapping. The IQR (3rd quartile−2nd quantile)**2 of gradients is added in the loss function to keep it constant it is also to strengthen the idea that the gradient should not explode. In order to ensure that the gradient does not explode, any abrupt change in gradient is avoided by restricting any change in gradient by tracking the mean of gradient change with respect to earlier gradient. The mean of the gradient change is given by equation (3):

mean of the gradient change=(delta gradient−mean(delta gradient))**2 (3)

In an embodiment, (abs(gradient)−n)**2 is added to a loss function so that gradient will be penalized as it crosses the n so the process will be smooth and not abrupt with a gradient clipping. In a preferred embodiment, n=6. The loss function is the error function that is needed to be minimized to achieve better performance in the target accuracy metric like accuracy. In an embodiment, an integer only softmax is computed during pseudo cross entropy computation. The softmax is used to convert the input given to it to a probability distribution at the same time flaring up the higher inputs and diminishing the lower inputs. But the softmax cannot be calculated in an integer only setting as it uses the Euler's number (e) for converting logits to probability. So to get the same effect as softmax, (e) can be replaced with 2. The softmax is given by softmax e*x/sum(e*x), where x is the input and an integer only softmax 2*x/sum(2*x) where x is the input.

Consider For Example:
[1.0,−1.0] after softmax->[0.88079707797,0.11920292202]
[1.0-1.0] after Integer only softmax->[0.8,0.2]

Accordingly, log 2 can be approximated as highest power of 2. However, when it comes to taking loss, the term log 2(sum(2**classes_score)) is encountered. The present technology does better than just simply taking the highest 2 power. The pseudo cross entropy is given by equation (4):

Pseudo cross entropy=log 2(class_nearest_shift)−log 2(class_nearest_mul)(for all class)−(log 2(sum_nearest_shift)+log 2(sum_nearest_mul))*num_classes (4)

At step 228, gradients are computed and back propagation is performed. The back propagation in QAT involves conversion of integer values to floating point values and then the gradients are updated. Subsequent to the update, the gradients are again converted to integer. At step 230, weight parameters are adjusted in low precision. At step 232, the multiplier and shift values error are adjusted and updated and steps 218 to 232 are repeated.

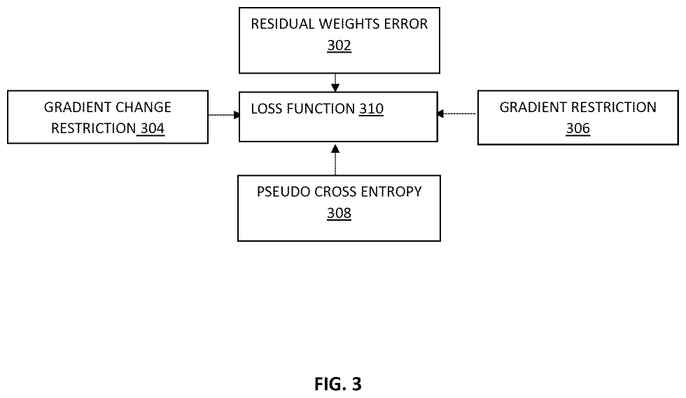

FIG. 3 depicts a schematic diagram for computing a loss function, according to an embodiment herein. In an embodiment, a loss function 310 is given by equation (4):

loss_function=pseudo_cross_entropy+gradient_restricton+gradient_change_restriction+residual weight error(multiplier and shift value error) (4).

Accordingly, residual weight error 302, gradient change restriction 304, gradient restriction 306 and pseudo cross entropy 308 are used to compute the loss function 310 based on the above equation. The residual weight error 302 is the error in the weights that occurs due to multiplier and shifter approximation while subtracting the gradients.

The residual weight error 302 is given by equation (5):

residual weight error=(Original_weight(int32)−(converted_weight_int8_to_int32))**2 (5)

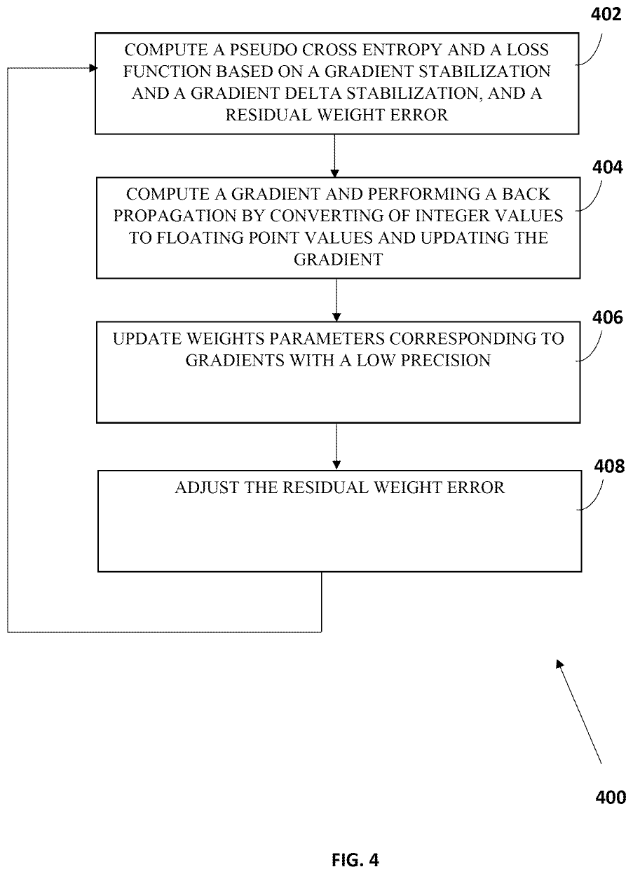

FIG. 4 depicts a flow diagram illustrating the steps involved in the method 400 for integer only quantization aware training on edge devices, according to an embodiment herein. At step 402, a pseudo cross entropy and a loss function is computed based on a gradient stabilization and a gradient delta stabilization, and a residual weight error. At step 404, a gradient is computed and a back propagation is performed by converting of integer values to floating point values and updating the gradient. At step 406, weights parameters corresponding to gradients are updated with a low precision. At step 408, the residual weight error is adjusted and repeating the above steps 402 to 408 are repeated for a predetermined number of epochs. In an embodiment, the predetermined number of epochs includes 5.

Various embodiments of the present technology perform full integer only quantization aware training and therefore can be used in full integer only hardware. Additionally, various operations of the present system require 8 bits or very rarely 32 bit for calculating some metrics and accordingly the present system is highly memory efficient. Moreover, since only bit shift and addition are used, the present technology can be virtually applied on every hardware without the need of any complex hardware instruction set or advanced software implementations.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

Although the embodiments herein are described with various specific embodiments, it will be obvious for a person skilled in the art to practice the embodiments herein with modifications. The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer-implemented method comprising instructions stored on a non-transitory computer readable storage medium and executed on a hardware processor in a computing device, for integer only quantization aware training on an edge device, the method comprising steps of:
a) computing a pseudo cross entropy and a loss function based on a gradient stabilization and a gradient delta stabilization, and a residual weight error;
b) computing a gradient and performing a back propagation by converting of integer values to floating point values and updating the gradient;
c) updating weights parameters corresponding to gradients with a low precision; and
d) adjusting the residual weight error and repeating the steps a) to c) for a predetermined number of epochs.

2. The method according to claim 1, wherein the step of computing the pseudo cross entropy loss function comprises:
computing a gradient stabilization and a gradient delta stabilization;
computing an integer only softmax, wherein the integer only softmax is given by: 2*x/sum(2*x) where x is an input; and
adjusting multiplier and shift values error based on the integer only softmax.

3. The computer-implemented method of claim 1, further comprises:
determining if a performance is acceptable after every predetermined number of epochs;
starting a quant aware training (QAT) upon the performance not being acceptable, by transferring the training data to the edge device; and continuing performing inference upon the performance being acceptable, by using a real time feed.

4. The computer-implemented method of claim 3, further comprises performing prior to continuing inference:
a) pre-training a floating model on a full dataset;
b) performing a post training quantisation;
c) determining if a predetermined accuracy is achieved;
d) repeating steps b) and c) upon the predetermined accuracy not being achieved; and
e) obtaining integer weights biases and activation scales and transferring to edge devices upon the predetermined accuracy being achieved and continue performing interference.

5. The computer-implemented method of claim 1, wherein computing the gradient comprises:
applying a gradient restriction by tracking a mean of gradient change with respect to an earlier gradient based on twice a delta gradient-mean (delta gradient);
wherein a variance of the delta gradient is within a predetermined range, and wherein post quantization trained weights are used as prior for a first gradient change.

6. The computer-implemented method of claim 5, further comprises:
adding (abs(gradient)−n)**2 to loss function for restricting the gradient to be within n; and
adding a delta of gradient in a subtracted delta gradient mean for each layer to constrain the gradient change, wherein the delta gradient is added based on equation:
gradient_change_restriction=(delta gradient−mean(delta gradient))**2.

7. The computer-implemented method of claim 5, further comprising steps of:
a) checking a scale in an interquartile range (IQR) of gradient for re-mapping and adding the IQR of the gradients to the loss function;
b) modifying a cross entropy of the loss function to an integer only pseudo_cross_entropy, wherein the loss function is given by equation:
loss_function=pseudo_cross_entropy+gradient_restriction+gradient_change_restriction+weights_resiudal_error(MUL/SHIFT error;
c) replacing a softmax with 2 in e and mapping a max with 2**31, wherein a custom softmax is given by equation:
custom softmax=2**mapped_value_class/sum(2**mapped_classes); and
wherein pseudo cross entropy is given by equation:
pseudo cross entropy=log 2(class_nearest_shift)−log 2(class_nearest_mul)(for all class)−(log 2(sum_nearest_shift)+log 2(sum_nearest_mul))*num_classes; and
d) recursively repeating steps, a) to c) for 5 to 10 cycles.

8. A system for integer only quantization aware training on an edge device, the system comprising steps of:
a memory for storing one or more executable modules; and
a processor for executing the one or more executable models for integer only quantization aware training, the one or more executable modules comprising steps of:
a pseudo cross entropy module configured to compute a pseudo cross entropy and a loss function based on a gradient stabilization and a gradient delta stabilization, and a residual weight error;
a gradient module for computing a gradient and performing a back propagation by converting of integer values to floating point values and updating the gradient;
a weight update module for updating weights parameters corresponding to gradients with a low precision; and
an error adjustment module for adjusting the residual weight error and repeating the process of computing a pseudo cross entropy and a loss function, performing a back propagation, and updating weights parameters corresponding to gradients for a predetermined number of epochs.

9. The system of claim 8, wherein pseudo cross entropy module is further configured to:
compute a gradient stabilization and a gradient delta stabilization;
compute an integer only softmax, wherein the integer only softmax is given by: 2*x/sum(2*x) where x is an input; and
adjust multiplier and shift values error based on the integer only softmax.

10. The system of claim 8, further comprises a training module for performing the steps of:
determining if a performance is acceptable after every predetermined number of epochs;
starting a quant aware training (QAT) upon the performance not being acceptable, by transferring the training data to the edge device; and
continuing performing inference upon the performance being acceptable, by using a real time feed.

11. The system of claim 10, wherein the training module is further configured for performing prior to continuing inference:
a) pre-training a floating model on a full dataset;
b) performing a post training quantisation;
c) determining if a predetermined accuracy is achieved;
d) repeating steps b) and c) upon the predetermined accuracy not being achieved; and
e) obtaining integer weights biases and activation scales and transferring to edge devices upon the predetermined accuracy being achieved and continue performing interference.

12. The system of claim 8, wherein the gradient module is further configured for:
applying a gradient restriction by tracking a mean of gradient change with respect to an earlier gradient based on (delta gradient−mean (delta gradient))**2;
wherein a variance of the delta gradient is within a predetermined range, and wherein post quantization trained weights are used as prior for a first gradient change.

13. The system of claim 8, wherein the gradient module is further configured for:
adding (abs(gradient)−n)**2 to loss function for restricting the gradient to be within n; and
adding a delta of gradient in a subtracted delta gradient mean for each layer to constrain the gradient change, wherein the delta gradient is added based on equation:
gradient_change_restriction=(delta gradient−mean(delta gradient))**2.

14. The system of claim 8, wherein the gradient module is further configured for:
a) checking a scale in an interquartile range (IQR) of gradient for re-mapping and adding the IQR of the gradients to the loss function; and
b) modifying a cross entropy of the loss function to an integer only pseudo_cross_entropy, wherein the loss function is given by equation:
loss_function=pseudo_cross_entropy+gradient_restriction+gradient_change_restriction+weights_resiudal_error(MUL/SHIFT error.
c) replacing a softmax with 2 in e and mapping a max with 2**31, wherein a custom softmax is given by equation:
custom softmax=2**mapped_value_class/sum(2**mapped_classes); and
wherein pseudo cross entropy is given by equation:
pseudo cross entropy=log 2(class_nearest_shift)−log 2(class_nearest_mul)(for all class)−(log 2(sum_nearest_shift)+log 2(sum_nearest_mul))*num_classes; and
d) recursively repeating steps a) to c) for 5 to 10 cycles.
